(19) United States
(12) Patent Application Publication
(10) Pub. No.: US 2008/0125262 A1
(43) Pub. Date: May 29, 2008

(54) Chain for use in automobile engine

(75) Inventor: Shota Miyanaga, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/895,771

(22) Filed: Aug. 27, 2007

(30) Foreign Application Priority Data
Nov. 28, 2006 (JP) 2006-320802

(51) Int. Cl. F16G 13/06; B32B 15/00

(52) U.S. Cl. 474/206; 428/472

(57) ABSTRACT

The pins of a roller chain or rollerless bushing chain for an automobile engine are subjected to chromizing treatment that forms a two part outer layer having a thick inner section composed primarily of Cr₇C₃ and a thinner, outermost, layer composed primarily of Cr₂₃C₆. The outer layer has convex protrusions and concave recesses. The protrusions are partially removed by barrel polishing to a level such that the depth of each recess is sufficient, but not substantially greater than necessary, for an inclusion received therein to be substantially entirely below the outer surface of the pin, thereby making the surface pressure exerted by portions of the pin on a surrounding bushing substantially as small as possible without exposure of inclusions beyond the outer surface of the pin.

### CROSS-REFERENCE TO RELATED APPLICATION

This application claims priority from Japanese patent application 2006-320802, filed Nov. 28, 2006. The disclosure of Japanese patent application 2006-320802 is incorporated by reference.

### FIELD OF THE INVENTION

This invention relates to a power transmitting chain for use in an automobile engine and a camshaft driving chain, and more specifically it relates to a timing chain for use in an automobile engine.

### BACKGROUND OF THE INVENTION

Metal roller chains, and rollerless chains known as bushing chains, have come into increasing use as power transmitting media for automobile engines, and have displaced toothed belts and V-belts because of the demand for reliable high speed operation, greater endurance, and increased capacity to withstand mechanical loads, and also because roller chains and bushing chains require less maintenance, and afford greater freedom in the design of the engine layout.

A typical metal chain for use in an automobile engine, is composed of alternating bushing links and pin links. In each bushing link, one end of each bushing of a pair of cylindrical bushings is press-fit into one of two bushing holes in an inner plate, and the opposite ends of the two bushings are similarly press-fit into bushing holes in an opposite inner plate. In the same way, in each pin link, one end of each pin of a pair of pins is press-fit into one of two pin holes in an outer plate, and the opposite ends of the two pins are press-fit into pin holes in an opposite outer plate. The inner plates of the bushing links are interleaved with the outer plates of the pin links, and each pin of a pin link extends loosely though a bushing of an adjacent bushing link so that a flexible chain is formed. In the case of a bushing chain, the bushings themselves engage driving and driven sprockets. In the case of a roller chain, a hollow, cylindrical roller, surrounding each bushing, and rotatable thereon, engages the sprockets.

In conventional chains, the pins are typically subjected to heat treatment, including quench hardening and tempering, and to carburizing and nitriding treatments or the like. In some cases, the surfaces of the pin have been subjected to surface hardening by boronizing or chromizing treatments and the like. The pins have also been plated with nickel or the like. Such treatments are mentioned in various patents, for example, U.S. Pat. No. 4,995,852.

When a conventional timing chain is used in highly deteriorated lubricating oil with a high degree of oxidation, it is subjected to the influences of oxidation or corrosion, and can wear excessively due to adhesion between the pins and the bushings, and as a result, the useful life of the chain is shortened. United States Patent Publication 2005/0090348 describes a chain in which the problems caused by deteriorated lubricating oil were addressed by subjecting the material of the bushing to carburizing treatment, and forming a vanadium carbide (VC) layer on the surfaces of the pins.

A silent chain has also been proposed in which, after a connecting pin is subjected to vanadium carbide (VC) treatment, the outermost surface layer of the base material is fully removed by barrel polishing treatment so that a vanadium carbide (VC) layer, with impurities removed and containing V₈C₇, is formed on the outermost layer of the base material. This chain is described in Japanese Laid-Open Patent Publication No. 2005-290435.

Chains in which the pins are subjected to surface treatment by boronizing or chromizing, and plated with nickel or the like, have been used in motorcycles and industrial equipment. However, it has been reported that, when such chains are used as timing chains in automobile engines, there have been instances in which the expected endurance is not achieved, and abnormal wear elongation occurs.

In a chain in which the material of the bushing is subjected to carburizing treatment, and a vanadium carbide layer is formed on the surfaces of the connecting pins, as in U.S. Patent Application Publication 2005/0090348, wear due to adhesion of the bushing to the pin is suppressed. However, because heat treatment, and treatment to form the vanadium carbide layer are required, the manufacturing cost of such a chain is high.

When the surface treatment described in Japanese Laid-Open Patent Publication No. 2005-290435 is adapted for use in a roller chain or bushing chain for an automobile engine, the inner surface of the bushings appear to become corroded by highly oxidized lubricating oil, and wear of mutually contacting surfaces of the bushings and the connecting pins is promoted, especially where the surface pressure is high under high mechanical loads. Moreover, since the outermost surface layer of the pin is fully removed by barrel polishing, when the treatment is adapted to a roller chain or a bushing chain, powder generated by wear at the mutually contacting surfaces of the pins and the bushings remains as inclusions between the pins and the bushings. These inclusions promote abrasive wear, which causes abnormal wear of the mutually sliding surfaces of the pin and the bushing. The results achieved by this adaptation were no better than those achieved in the case where barrel polishing treatment was applied to a silent chain.

Where the pins and the bushings of a bushing chain or a roller chain are composed of materials having a high affinity for each other, for example in the case where the pins and bushings are composed of the same element, the pins are liable to adhere to the bushings, and the adhesion of the pins to the bushings impairs smooth flexing and sliding of the chain.

Accordingly, an object of the invention is to solve the above-mentioned problems of a conventional chain. In particular, the invention provides a chain for use in an automobile engine, in which, even if the chain is lubricated by a deteriorated lubricating oil containing inclusions and having high degree of oxidation, abnormal wear elongation due to abrasive wear of the mutually sliding surfaces the pins and bushings is avoided. Moreover, even if the pins and the bushings are composed of materials having a high affinity for each other, e.g., if the pins and bushings are composed of identical elements, they are not liable to adhere to each other, and wear due to “adhesion” is suppressed, so that smooth flexing and sliding of the chain can take place over a long period of time.

Another object of the invention is to provide a chain for use in an automobile engine which can maintain superior lubricity over a long period of time.

Still another object of the invention is to provide a chain for use in an automobile engine in which the initial wear of a bushing, sometimes referred to as the bushing's “attackability,” is reduced. A consequence of the reduction in the attackability of the bushing is that the shock resistance of the chain is improved.

### SUMMARY OF THE INVENTION

The chain according to the invention is a roller chain or bushing chain comprising pairs of inner plates and pairs of outer plates in alternating, overlapping relationship along the length of the chain. The chain includes a pair of bushings for each pair of inner plates, and ends of the bushings are press-fit into bushing holes in the inner plates. The chain also includes a pair of pins for each pair of outer plates, and ends of the pins are similarly press-fit into pin holes in the outer plates. Each pin has an outer surface, and extends through, and fits loosely in, one of said bushings.

Each pin comprises a base material having a surface, and having a chromium carbide layer formed on the surface of the base material by diffusion penetration. The chromium carbide layer extends from the surface of the base material of the pin to an outer surface of the pin, and comprises two distinct layers: an inner layer principally composed of Cr₇C₃ and an outermost layer principally composed of Cr₂₃C₆. The inner layer is preferably thicker than the outer layer. Concave recesses are formed in the outermost layer, and are of a size sufficient to receive inclusions in automobile engine lubricating oil. The depth of each recess is sufficient, but not substantially greater than necessary, for an inclusion received therein to be substantially entirely below the outer surface of the pin. As a result, the surface pressure exerted by portions of the pin on the inside of a surrounding bushing can be made substantially as small as possible without exposure of inclusions contained in the concave recesses beyond the outer surface of the pin.

The pins are subjected to barrel polishing, which reduces the depths of the recesses and increases the total area of the outer surface of the pins, thereby reducing the surface pressure exerted by the pins on the inside of the bushings. Thus, the depths of the recesses are established by the barrel polishing process.

The thickness of the outermost layer, i.e., the layer principally composed of Cr₂₃C₆, is preferably within the range from 1 to 6 μm, and is at least as great as the depths of the concave recesses. Thus, the concave recesses are disposed substantially entirely within the outermost layer.

Preferably, the depth of each recess is sufficient, but not substantially greater than necessary, for an inclusion received therein, and having a maximum dimension equal to one-half the thickness of the outermost layer, to be substantially entirely below the outer surface of the pin.

The Cr₇C₃ layer formed on the base material side of the chromium carbide layer and the outermost Cr₂₃C₆ layer have different qualities. The layer principally composed of Cr₇C₃ exhibits a high degree of hardness, while the layer principally composed of Cr₂₃C₆ exhibits superior wear resistance, porosity, heat resistance and lubricity. Even when the chain is used in an extremely deteriorated lubricating oil having a high degree of oxidation, abnormal wear elongation is suppressed, and at the same time excellent wear resistance, heat resistance, and lubricity are achieved.

Inclusions such as soot or the like in lubricating oil are especially liable to be present in a direct injection gasoline engine or a diesel engine, and can prevent the formation of an oil film on the surface of a pin in a conventional roller chain or bushing chain. In the chain according to the invention, however, the concave recesses formed in the layer on the pins principally composed of Cr₂₃C₆ are large enough to receive these inclusion. However, the recesses are preferably only deep enough to receive the inclusions, so that the inclusions do not protrude and interrupt the oil film on the outer surfaces of the pins. As a result, the surface pressure exerted by the pin on the inner surface of the bushing is maintained substantially at a minimum level. At the same time, since the inclusions are not present at the sliding contact surfaces of the pin and the bushing, abrasive wear is suppressed, and wear elongation of the chain due to abrasive wear is decreased. The concave recesses also serve as oil reservoirs, which contribute to superior lubricity in the chain.

### BRIEF DESCRIPTION OF THE DRAWINGS

FIG. 1 is a perspective view showing a part of a roller chain according to the invention.

FIG. 2(a) FIG. 2(a) is a schematically view of the cross-section of the outermost layer of a chromium carbide layer formed on a surface of a pin according to the invention;

FIG. 2(b) is a schematic view showing the surface of a pin subjected to roughness treatment such as barrel polishing, carried out to the level of broken line B in FIG. 2(a);

FIG. 2(c) is a schematic view showing the surface of a pin subjected to roughness treatment when carried out to the level of broken line C in FIG. 2(a);

FIG. 2(d) is a schematic view showing the surface of a pin subjected to roughness treatment when carried out to the level of broken line D in FIG. 2(a);

FIG. 3 is a cross-sectional structure photograph of a pin in the roller chain of the invention;

FIG. 4 is a schematic view explaining the structure of the cross-section of a surface of the pin of the invention; and

FIG. 5 is a graph showing the results of chain elongation tests in deteriorated lubricating oil for the roller chain of the invention and for two conventional examples.

### DETAILED DESCRIPTION OF THE PREFERRED EMBODIMENTS

The invention will be described with reference to a roller chain. However, a purpose of the invention is to reduce deterioration of a chain due to the sliding contact between the inner surface of a bushing and the outer surface of a pin, and the principles of the invention are equally applicable to roller chains and to rollerless bushing chains.

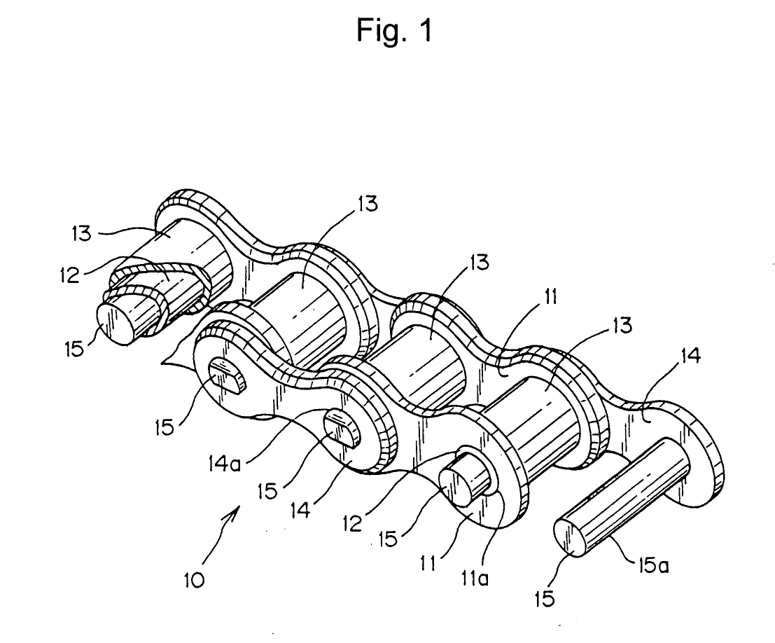

As shown in FIG. 1, in a roller chain 10, both ends of each bushing 12 are press-fit into bushing holes 11a in a pair of opposite inner plates 11. Pins 15 fit loosely through the bushings, and both ends of each pin 15 are press-fit into pin holes 14a in a pair of outer plates 14 disposed in overlapping relationship with the inner plates on the outer sides thereof. The bushings extend through rollers 13, which are rotatable on the bushings.

In the roller chain 10 of the invention, the bushings 12 are composed of alloy steel. The base material of the pins is also steel, and can be a high carbon or low-carbon steel. When the base material of the pins is low-carbon steel, a high carbon surface layer is formed on the surface 15a of the base material of each pin 15. Although the method by which the high carbon surface layer is formed is not particularly limited, it is preferably carried out by a carburizing treatment in which the pin is heated at approximately 900° C. to 950° C. in a carburizing agent in order to diffuse carbon into the pin and thereby increase the carbon content in the surface layer. When high carbon steel is used as the base material of the pin 15, the carburizing treatment is not needed.

A chromizing layer (that is, a diffused chromium layer) is formed on a surface of the pin 15 by the “powder pack” method. The powder pack method is a diffusion penetration treatment by which the periphery of the pin 15 is heat-treated while in contact with a chromium powder or a chromium alloy powder. The pin is preferably heat-treated at a temperature in the range from 900° C. to 1200° C. for 5 to 25 hours. When the powder pack method is carried out, an anti-sintering agent such as alumina or the like and a reaction promoting agent such as ammonium chloride or the like are added.

In the example described herein, the chromizing layer is formed on the surface of the pin 15 by the powder pack method. However, as an alternative, the so-called molten salt method, (which is also popularly referred to as “Toyota Diffusion”) is used, in which the pin is treated in molten salt. In another application method, chromium powder and a suspending agent with added coating material are applied to the pin. The pin is then dried and heated in an inert gas or in a vacuum. The powder pack method is preferred for the chromizing treatment of pins of roller chains and bushing chains because it is inexpensive and especially suitable for treatment of small articles.

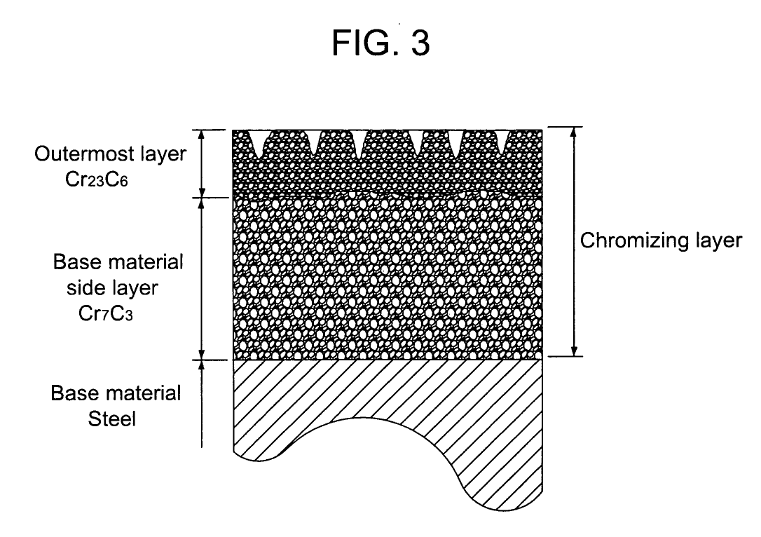

As described above, a chromizing layer is formed on a high carbon surface layer of the pin by a diffusion penetration treatment in which the treatment temperature is about 1000° C. Carbon contained in the high carbon surface layer of the pin 15, and in the base material of the pin, penetrates a chromizing layer formed on the surface of the pin in and combines with chromium (Cr) in the chromizing layer. As can be seen in FIG. 3, which is a cross-sectional structure photograph of the surface of a pin, taken by an electron microscope, the chromizing layer is composed of two parts: a layer principally composed of Cr₇C₃ next to the base material, and an outermost layer principally composed of Cr₂₃C₆.

The thickness of the base material side inner chromium carbide layer, i.e., the layer principally composed of Cr₇C₃, is in the range from 8 to 20 μm, and the thickness of the outermost chromium carbide layer, which is principally composed of Cr₂₃C₆, is in the range from 1 to 6 μm. The reason why the chromizing layer on the surface of the pin becomes divided into two layers is not clearly understood at present. However, it appears that, when chromium, supplied as a treatment powder is combined with carbon supplied from the high carbon surface layer of the base material of the pin, a layer principally composed of Cr₇C₃, having a relatively a high ratio of carbon to chromium, is formed in the vicinity of the base material, and a layer principally composed of Cr₂₃C₆, having a relatively low ratio of carbon to chromium, is formed at the outermost surface remote from the base material. It is believed that a balancing between the two solid phases in the process of their formation causes the two divided layers to be formed.

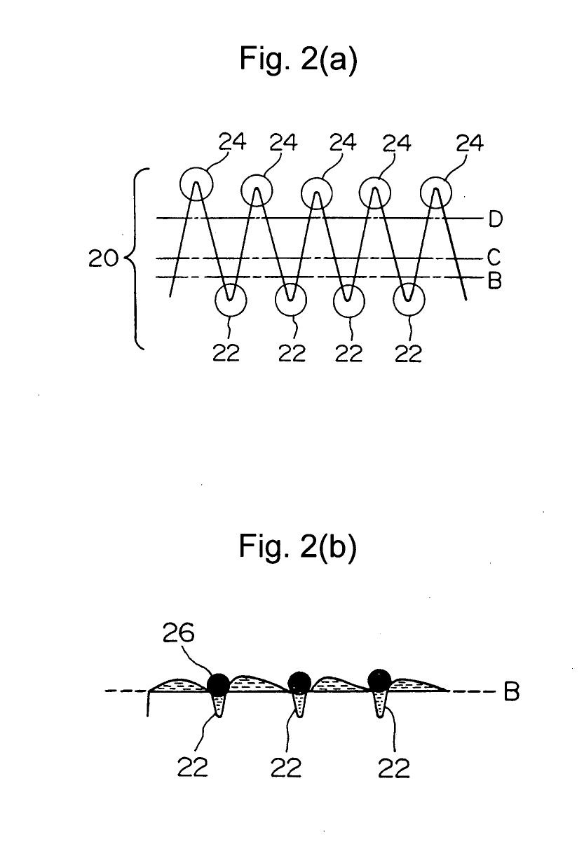

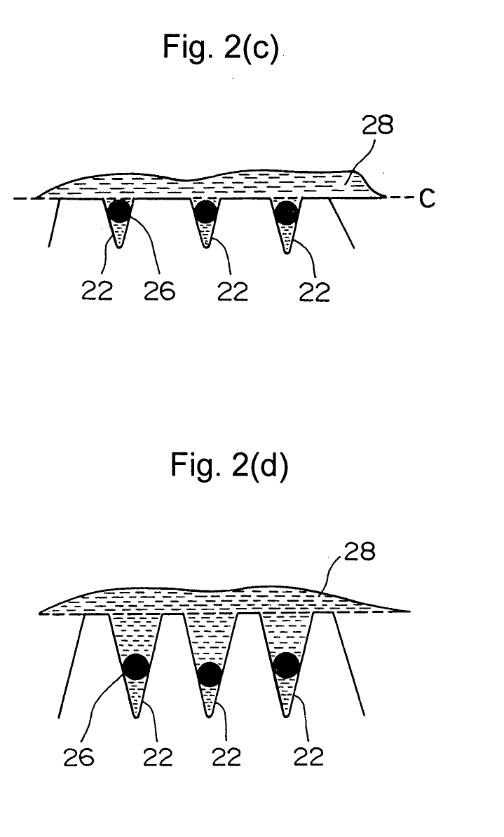

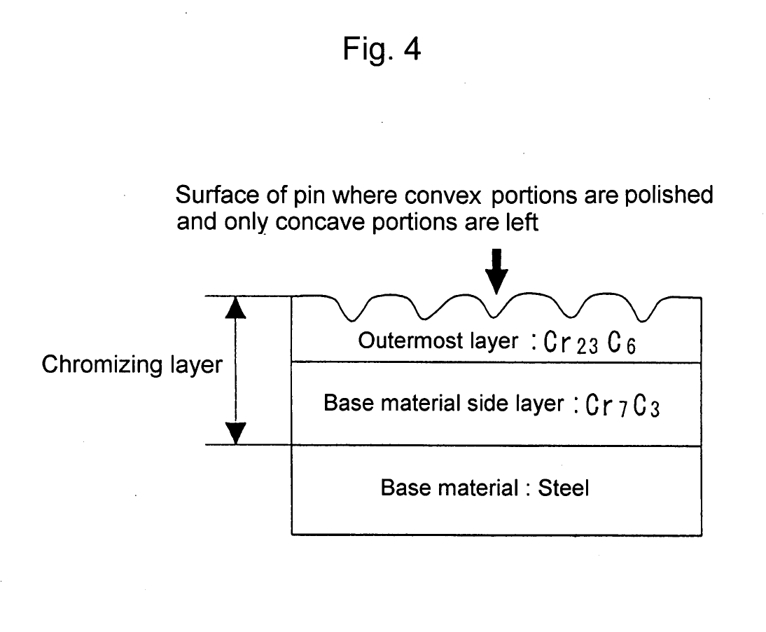

Following the chromizing treatment, the surface of the pin is subjected to barrel-polishing. The surface initially has convex protrusions 24, and concave recesses 22, as depicted schematically in FIG. 2(a). The barrel polishing time must be sufficient to smooth out the convex protrusions so that the surface pressure is significantly reduced, but not so long as to grind the outer layer to the point where the concave recesses are of insufficient size to receive inclusions such as soot in lubricating oil. The barrel polishing process applied to the pin leaves an outermost layer exhibiting excellent wear resistance and principally composed of Cr₂₃C₆. To form concave recesses of the kind depicted in FIG. 2(c), the barrel-polishing treatment time is determined experimentally by sequentially applying barrel polishing over different treatment times, and taking cross-sectional images of the pins by an electron microscope to determine the size of the concave recesses on the pins. After the appropriate barrel polishing treatment time is determined, pins having concave surface recesses of the appropriate size can be formed reproducibly in production. A schematic cross-sectional view of the surface layer of a pin is shown in FIG. 4.

The concave recesses are of a size sufficient to receive inclusions in automobile engine lubricating oil, and the depth of each recess is sufficient, but not substantially greater than necessary, for an inclusion received therein to be substantially entirely below the outer surface of the pin. Consequently, the surface pressure exerted by portions of the pin on a surrounding bushing is substantially as small as possible without exposure of inclusions contained in the concave recesses beyond the outer surface of the pin. As mentioned previously, the thickness of the outermost layer should be in the range from 1 to 6 μm, The thickness of the outermost layer should be greater than the depth of the recesses, so that the recesses are substantially entirely within the outermost layer. Preferably, the depth of each recess is sufficient, but not substantially greater than necessary, for an inclusion received therein, and having a maximum dimension equal to one-half the thickness of the outermost layer, to be substantially entirely below the outer surface of the pin.

FIG. 2(a) schematically depicts the cross-section of the outermost layer 20 of a chromium carbide layer formed on the surface of a pin. When the outermost layer 20, which is principally composed of Cr₂₃C₆, is not subjected to surface roughness modification, it has a convex protrusions 24 and a concave recesses 22. The pressure exerted by the narrow convex portion 24 is high because their total area is relatively small. Consequently, the protrusions attack the inner surfaces of the bushings.

FIG. 2(b) schematically shows a pin surface that has been subjected to a roughness modification treatment, such as a barrel polishing, carried out to the level of broken line B in FIG. 2(a). In this case, almost all of the convex protrusions 24 in FIG. 2(a) have been removed by polishing. The ability of the protrusions to attack the interior of the bushings is almost entirely eliminated. However, the polishing process reduces the size of the concave recesses 22 to the extent that inclusions 26, such as soot in lubricating oil cannot be received in the concave recesses 22, and instead exist on the surface of the pin. These exposed inclusions prevent the formation of oil films, and can attack the interior surface of the bushings by abrasion.

FIG. 2(c) schematically shows a pin in which the surface roughness treatment was carried out to the level of broken line C in FIG. 2(a), which is at an intermediate location, approximately midway between the peaks of the protrusions 24 and the bottoms of the recesses 22. In practice, as shown in FIG. 2(a) the line C is slightly below the midpoint between the peaks of protrusions 24 and the bottoms of recesses 22. The concave recesses 22 are of a size such that they can receive inclusions 26, in such a way that the inclusions are entirely, or almost entirely, below the polished outer surface of the outermost Cr₂₃C₆ layer. Thus, an oil film 28 can be formed on the outer surface of the pin. Since the convex protrusions 24 are polished to level C, the surface pressure exerted by the convex protrusions is relatively small, and consequently, the attack on the inner surfaces of the bushings by the protrusions is substantially reduced.

FIG. 2(d) schematically shows a pin in which the surface roughness treatment was carried out only to the level of broken line D in FIG. 2(a) In this case, only the peaks of the convex protrusions 24 shown in FIG. 2(a) are removed by polishing polished. Inclusions 26 such, as soot in lubricating oil can be received in the concave recesses, and an oil film 28 is formed. However, the total area at the outer surface of the pin is relatively small and the surface pressure exerted by the pins on the inner surfaces of the bushings is high, and the attack on the bushings is relatively high.

Although it has been considered that the better the smoothness of the surface of a pin is, the more its wear resistance is improved, as can be understood from the above explanation, excessive surface roughness treatment of the pin promotes wear of the pin in cases where inclusions such as soot exist in the lubricating oil.

Other surface roughness treatments can be used, including superfinishing, chemical polishing and electrolytic polishing. In superfinishing, a workpiece in rolling contact with a grindstone is subjected to minute, low-frequency vibrations in the direction of the axis of rotation. In chemical polishing, the workpiece is immersed in a processing solution that smooths the surface of the workpiece by a chemical reaction, thereby imparting a brilliant finish to the work. In electrolytic polishing, a workpiece as an anode (+) and an cathodic electrode (−) are immersed in an electrolytic solution, and the surface of the work anode is eluted into the electrolytic solution. When barrel polishing is used as a treatment to reduce the surface roughness of the pins, polishing of small parts, such as pin for use in roller chains and bushing chains can be more efficiently carried out.

When the inner chromium carbide layer, i.e., the layer principally composed of Cr₇C₃ is thicker than an outer layer, principally composed of Cr₂₃C₆, the attack on the bushings is reduced, the shock resistance of the chain is improved, and abrasive loss of the bushing is suppressed.

These effects provide a chain for use in an automobile engine that exhibits high endurance, wear resistance, and shock resistance, and in which wear due to adhesion is also suppressed. The chain slides smoothly, and is capable of smooth flexing over a long period of time. These effects also effectively extend the lifetime of the lubricating oil used in an automobile engine and are therefore also environmentally beneficial.

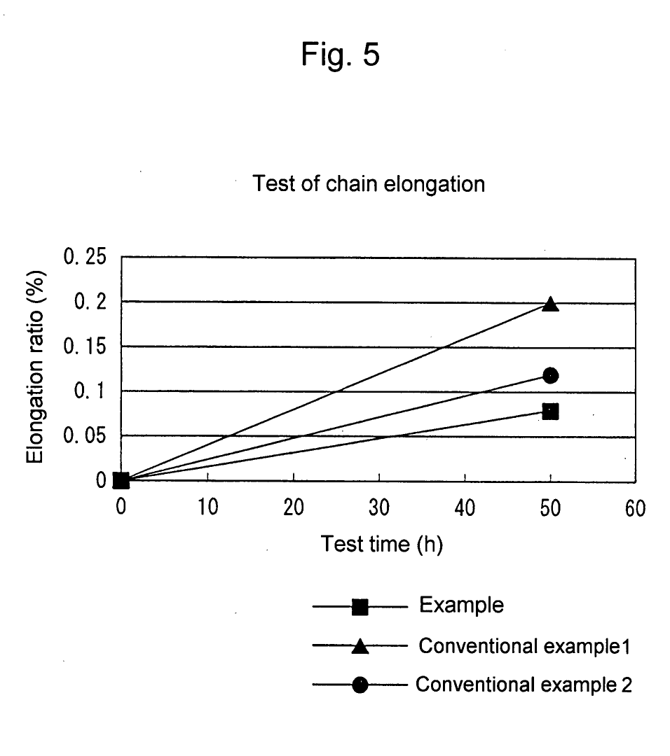

A wear elongation test was carried out to determine the properties of the pins of timing chains for use in an automobile engine, under the following test conditions:
Chain: roller chain having a pitch of 8 mm
Number of sprocket teeth in the timing drive: 18×36
Rotation speed: 6500 r/min
Lubricating oil: deteriorated engine oil
Amount of oil: 1 L/min
   The tests were carried out on a chain in accordance with the invention, and on two conventional chains, using a conventional chain elongation testing machine and method generally used in the art. The results of the tests are is shown in FIG. 5.

In conventional example 1, the pin was subjected to a full barrel polishing treatment, in which a Cr₂₃C₆ layer of was fully removed, but concave recesses were present in the outer surface of the pin. In conventional example 2, the concave recesses at the surface of the pin were removed by a finer polishing treatment, producing a smooth surface finish but leaving a Cr₂₃C₆ layer as the outermost layer.

From the results of the chain elongation test shown in FIG. 5, when a roller chain according to the invention is compared with roller chains of conventional examples 1 and 2 after a test time of 50 hours, the elongation ratio of the chain according to the invention was 0.08%, whereas the elongation ratio for conventional example 1 was 0.2% and the elongation ratio for conventional example 2 was 0.12%. Thus, the elongation ratio of the chain according to the invention was only about 40% of the elongation ratio of the chain f conventional example 1, and only about 67% of the elongation ratio of the chain of conventional example 2. As can be understood from these results, if the concave recesses at the surface of the pin are of a size to receive inclusions such as soot in lubricating oil, and the surface pressure of the pin is significantly reduced, while ensuring that the outermost (Cr₂₃C₆) layer remains, a synergistic effect between the effect of the outermost layer (Cr₂₃C₆) and the effect of the concave surface recesses is generated, and a remarkable improvement in the elongation ratio of the chain is achieved.

### INDUSTRIAL APPLICABILITY

It has been thought that, in a chain for an automobile engine, the more the surface roughness of the pin is reduced, the more the chain's wear elongation is reduced. However, after careful study, it has been newly recognized that, when a chain for an automobile engine is used under an environment where inclusions such as soot exist in the lubricating oil, excessive surface smoothness can promote the wear of the pins. Based on this knowledge, the chain in accordance with the invention has been developed, in which surface pressure is reduced while surface recesses are present in a size capable of receiving inclusions such as soot in oil. Its superior resistance to wear elongation can be achieved reproducibly without special production facilities and expensive materials.

I claim:

1. A power transmission chain for use in an automobile engine comprising:
pairs of inner plates and pairs of outer plates in alternating, overlapping relationship along the length of the chain;
a pair of bushings for each pair of inner plates, ends of the bushings being press-fit into bushing holes in the inner plates;
a pair of pins for each pair of outer plates, ends of the pins being press-fit into pin holes in the outer plates, each pin having an outer surface, and extending through, and fitting loosely in, one of said bushings;
wherein each pin comprises a base material having a surface, and having a chromium carbide layer formed on the surface of the base material by diffusion penetration and extending from the surface of the base material of the pin to an outer surface of the pin, the chromium carbide layer comprising an inner layer principally composed of Cr₇C₃ and an outermost layer principally composed of Cr₂₃C₆, and concave recesses formed in said outermost layer, the concave recesses being of a size sufficient to receive inclusions in automobile engine lubricating oil, and the depth of each recess being sufficient, but not substantially greater than necessary, for an inclusion received therein to be substantially entirely below said outer surface of the pin, whereby the surface pressure exerted by portions of the pin on a surrounding bushing is substantially as small as possible without exposure of inclusions contained in the concave recesses beyond said outer surface of the pin.

2. A power transmission chain according to claim 1, in which said inner layer, principally composed of Cr₇C₃, is thicker than said outermost layer, principally composed of Cr₂₃C₆.

3. A power transmission chain according to claim 1, in which said outer surface of the pin is polished by barrel polishing.

4. A power transmission chain according to claim 3, in which said inner layer, principally composed of Cr₇C₃, is thicker than said outermost layer, principally composed of Cr₂₃C₆.

5. A power transmission chain according to claim 1, the depth of said recesses is said outer surface of the pin is established by barrel polishing treatment of said outermost layer

6. A power transmission chain according to claim 5, in which said inner layer, principally composed of Cr₇C₃, is thicker than said outermost layer, principally composed of Cr₂₃C₆.

7. A power transmission chain according to claim 1, in which the thickness of said outermost layer, principally composed of Cr₂₃C₆, is within the range from 1 to 6 μm.

8. A power transmission chain according to claim 1, in which the thickness of said outermost layer, principally composed of Cr₂₃C₆, is at least as great as the depths of the concave recesses, whereby the concave recesses are disposed substantially entirely within said outermost layer.

9. A power transmission chain according to claim 1, in which the thickness of said outermost layer, principally composed of Cr₂₃C₆, is within the range from 1 to 6 μm, and is at least as great as the depths of the concave recesses, whereby the concave recesses are disposed substantially entirely within said outermost layer.

10. A power transmission chain according to claim 1, in which the thickness of said outermost layer, principally composed of Cr₂₃C₆, is within the range from 1 to 6 μm, and in which the depth of each recess is sufficient, but not substantially greater than necessary, for an inclusion received therein, and having a maximum dimension equal to one-half the thickness of said outermost layer, to be substantially entirely below said outer surface of the pin.

11. A power transmission chain according to claim 1, in which the thickness of said outermost layer, principally composed of Cr₂₃C₆, is within the range from 1 to 6 μm, and is at least as great as the depths of the concave recesses, whereby the concave recesses are disposed substantially entirely within said outermost layer, and in which the depth of each recess is sufficient, but not substantially greater than necessary, for an inclusion received therein, and having a maximum dimension equal to one-half the thickness of said outermost layer, to be substantially entirely below said outer surface of the pin.
